(19) United States
(12) Patent Application Publication
(10) Pub. No.: US 2005/0288970 A1
(43) Pub. Date: Dec. 29, 2005

(54) Automobile insurance during military deployment

(76) Inventors: Thomas H. Holcom, Kansas City, MO (US); Richard Katz, Overland Park, KS (US)

Correspondence Address: SHUGHART THOMSON & KILROY, PC, 120 WEST 12TH STREET, KANSAS CITY, MO, 64105, US

(21) Appl. No.: 11/132,014

(22) Filed: May 18, 2005

Related U.S. Application Data
(60) Provisional application No. 60/572,069, filed on May 18, 2004.

(51) Int. Cl. G06Q 40/00

(52) U.S. Cl. 705/4

(57) ABSTRACT

A method of allocating an insurance benefit to qualified military personnel is provided for military personnel that are deployed for overseas or long distance duty and who have stored a personal vehicle on an approved storage lot for the duration of the deployment.

### CLAIM OF PRIORITY

This application claims priority to U.S. Provisional Application Ser. No. 60/572,069 filed May 18, 2004.

### FIELD OF THE INVENTION

The present invention relates to automobile insurance policies, in particular, automobile insurance policies in which the insured is a member of the armed services who may be deployed overseas or to a distant base.

### BACKGROUND OF THE INVENTION

Persons with careers in the military are typically confronted with the need to move from one base to another base and yet to another during the course of a career or even a period of enlistment in the military. Such a change of bases is to be expected in military life. In the course of changing from one base to another, the member of the military will move their entire household from one location to another and begin the process of reconstituting their household and life in the new location. In such a transfer, all the possessions of the military personnel are transferred with them and new living quarters are obtained in the new location, and in that regard, the transfer is similar to the move of non-military personnel from one location to another.

However, military life presents at least one unique circumstance which is not found in civilian life-the overseas deployment or long distance temporary deployment. In such cases of military deployment, the member of the armed forces is given orders to report to an overseas station for duty or to report to a temporary but long term and distant duty station. In the case of military personnel in the Navy, they may receive orders to sail which may encompass six or more months of deployment aboard a boat or a ship. In the case of a long distance deployment, such a deployment for the purposes of this invention is considered to be a deployment to a location away from the permanent station of the military service member.

In cases of overseas deployment or long distance deployment, the military personnel are not moving to the new location with their possessions and automobile. They are, instead, leaving nearly all of their possessions behind, including their automobile, and storing these possessions at some, hopefully secure, location until they return from deployment. Unless the service member leaves behind family who will continue to use the possessions of the individual undergoing deployment, the possessions will receive no use and will be in permanent storage until the return of the individual from deployment. In the case of household possessions and the like, this presents little difference in terms of the insurance used to protect the value of these possessions. If the possessions are in storage, of if they are within a home, they are subject to the same or nearly same potential for fire and theft and catastrophic event damage. However, the automobile owned by the military personnel undergoes a substantial change in terms of its use, and the potential for damage that may occur to the automobile, and the need for insurance to cover the owner or driver of the automobile. This change is a direct result of the automobile being stored and not used by the deployed military personnel while on deployment, unless the car is left in the possession of relatives or friends who are allowed to use it.

When deployed military personnel do store their vehicle, they often have the option of storing the vehicle on a secure vehicle storage lot on the base from which they are deployed. While the vehicle is stored on the storage lot, it is not in use and secured against damage to the degree that the base is secured from intruders. However, the vehicle is still subject to weather damage if it is in an exposed lot and sun, wind and hail and the like. These continue to be a potential source of damage to the vehicle. However, such natural sources of damage to vehicles are clearly definable and can be accounted for apart from the potential for collision damage to the vehicle and the liability coverage risk for a driver and vehicle and the insurance premiums associated therewith. Thus different sources of risk and the cost to insure the risk can be distinctly determined and separate insurance costs can be associated with each component of risk.

Heretofore, these distinctions between the need for insurance coverage for an automobile that is possessed by military personnel versus military personnel on deployment has not been accounted for by the insurance industry. It also is clear from the circumstances previously described that the automobile of deployed military personnel is subject to less opportunity for collision damage, personal injury or liability insurance claims and the like. It will be appreciated, however, that for deployed military personnel as well as all other persons that the need to maintain sufficient insurance to protect the owner or a finance company against property damage to the vehicle must be maintained in all cases. It also should be appreciated that some state motor vehicle departments require that liability insurance be maintained and/or other types of insurance on vehicles that are registered within their state. If the owner of a vehicle in some states fails to maintain the proper insurance or proper levels of insurance the state will “force place” a policy on the vehicle. In cases in which the vehicle owner has been subject to such a “force placed” policy the state will require that the cost of the policy be paid before the vehicle can be re-registered. Often the cost of such “force placed” policies in well in excess of the cost of insurance in the competitive market place. Therefore, a benefit could be afforded military service personnel by providing state required levels of insurance while providing the absent military service person a discount on the premium for the policy which takes into account the reduced potential for vehicle damage and driver liability during those periods in which the vehicle is in a storage facility.

### SUMMARY OF THE INVENTION

Therefore, in view of the deficiencies of the insurance policies of the prior art, it would be a great benefit to military personnel if a means for differentiating between the insurance needs of deployed military service personnel and non-deployed military service personnel was available.

There would be a further benefit to military personnel if a method were available for determining the different insurance needs of deployed military personnel as compared to those of non-deployed military personnel.

Yet another advantage would be presented by an insurance policy which provided deployed military personnel who stored their vehicle on a secure military base vehicle storage lot or at a private storage lot previously approved of by the military or by an insurance provider a benefit in the cost of the insurance policy automobile coverage when the individual was deployed overseas.

Yet another benefit would be provided to military personnel if a method differentiating an insurance policy were available to permit military personnel who are deployed overseas or deployed over a long distance for duty to evidence storage of their vehicle on an approved military personnel vehicle storage lot and to receive a benefit from the insurance company related to the reduction in risk represented by the temporary non-use of the vehicle. Such a benefit could be either extended duration of the insurance policy or reduced cost of the insurance policy commensurate with the period of time the military personnel was deployed overseas or on long distance deployment or automatic extension of the insurance policy during the period of deployment.

These and other benefits are available in the present invention which provides a method qualifying military personnel as having been deployed for duty either overseas or on a long distance deployment and authenticating that a vehicle owned by the deployed military personnel had been secured on an approved military personnel storage lot for the duration of the deployment of the deployed military personage and allocating a benefit to the deployed military service member, the benefit being associated with the reduction in risk to the insurer represented by the storage of the vehicle on the approved military vehicle storage lot as compared to the continued active use of the vehicle during the period of time of deployment of the deployed military service member who is the owner of the vehicle. It will be understood by those skilled in the art that the benefit could be in the form of a reduced premium or a credit on future premiums or an automatic extension of the term of the policy or guaranteed extension of the insurance coverage during the term of deployment of the military personnel from their home base or other such benefit.

The foregoing and other objects are intended to be illustrative of the invention and are not meant in a limiting sense. Many possible embodiments of the invention may be made and will be readily evident upon a study of the following specification and accompanying drawings comprising a part thereof. Various features and sub-combinations of invention may be employed without reference to other features and sub-combinations. Other objects and advantages of this invention will become apparent from the following description taken in connection with the accompanying drawings, wherein is set forth by way of illustration and example, an embodiment of this invention.

### DESCRIPTION OF THE DRAWINGS

FIG. 1 shows a flow chart which schematically presents the method steps of the present invention.

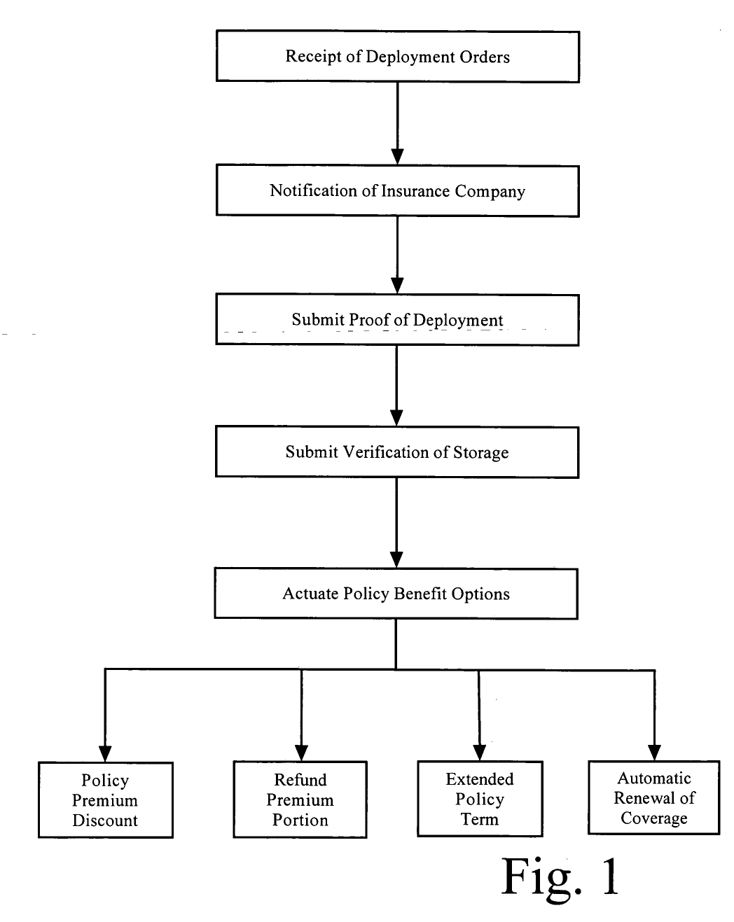

FIG. 2 shows a flow chart which schematically presents an alternate embodiment of the method steps of the present invention and which requires proof of the termination of the period of deployment by the military service person.

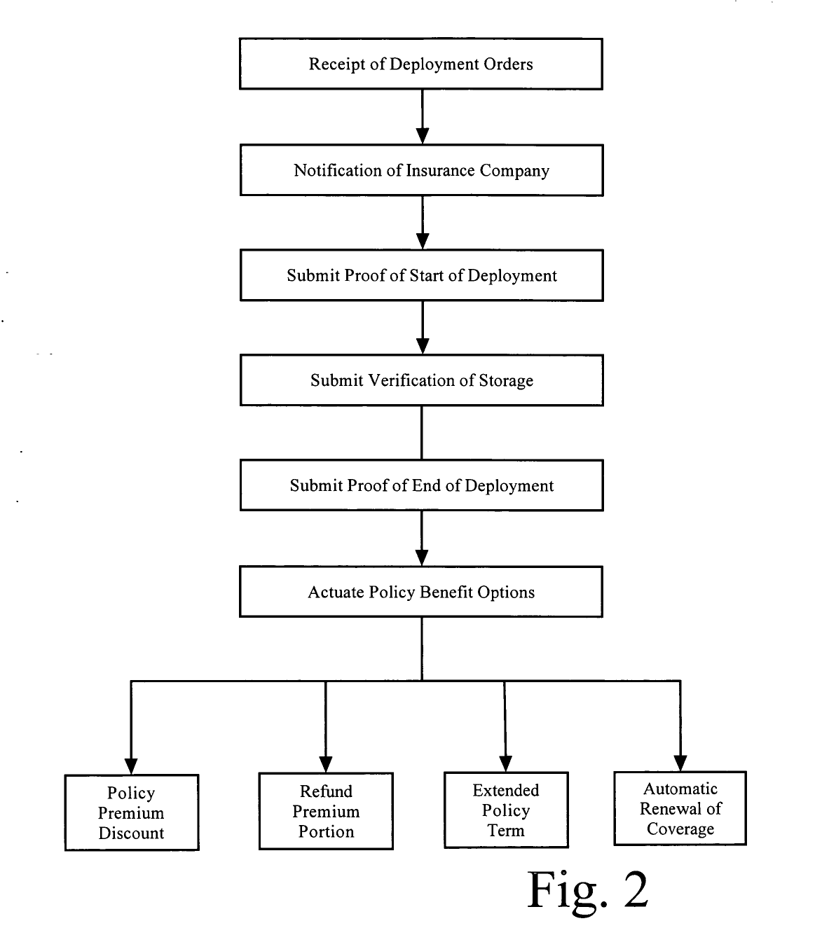

FIG. 3 shows a flow chart which schematically presents another alternate embodiment of the method steps of the present invention and which relies on proof of transfer of custody of the vehicle.

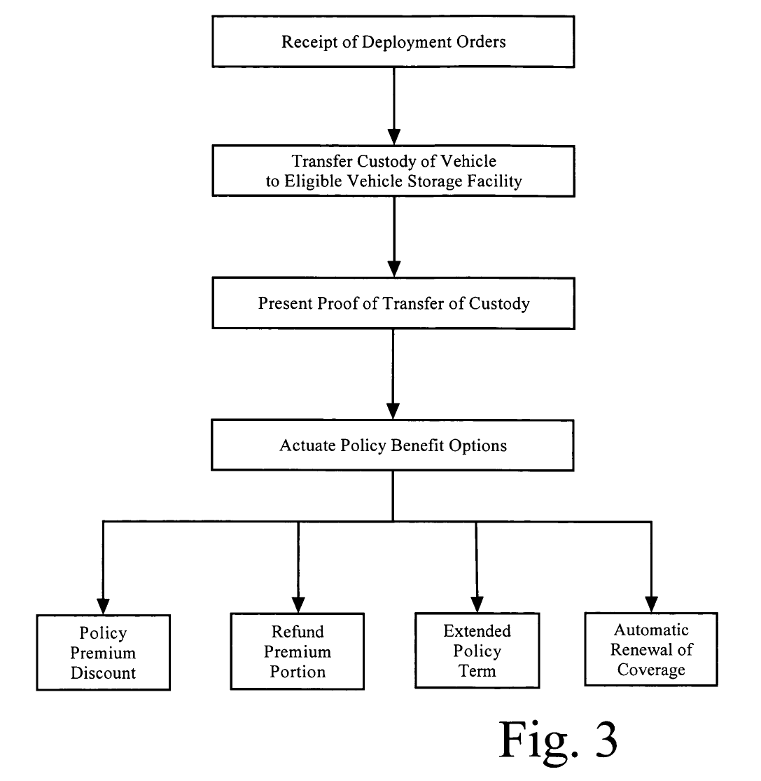

### DESCRIPTION OF THE PREFERRED EMBODIMENT

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. By way of example of the expansiveness of the language used herein, and not limitation, it will be appreciated that the term military service person or military service personnel can include persons in any branch of the military, active duty or reserve duty or retired—army, navy, marines, air force, national guard—or employee of the Department of Defense or member of the diplomatic corps that is to be re-stationed at a distance from their standard location.

During the course of military service, either as active duty or reserve duty, it is often the case that an individual be deployed overseas or be deployed to a base, other than their home base, for an extended period of time. Where the deployment to a base is a substantial distance and not overseas, the military personnel may act in the same fashion with respect to storage of their automobile as they would had they been stationed overseas. In particular, the military personnel will tend to store their automobile on a secure lot which is either on a military base or a lot which is approved as a secured storage lot by the military. If the military service member owns their automobile outright, they could, if they desired, completely cancel their automobile insurance for both liability coverage and collision or damage coverage to the property during their period of extended absence and non-use of the vehicle. However, if the automobile is the subject of a loan, it usually will not be possible for the individual to allow the insurance to lapse. Alternatively, if the automobile is of sufficient value, the individual may wish to continue the automobile property or collision coverage during the time that they are deployed and not using the automobile to assure that they will be compensated for the value of their property should some damage befall it.

However, in each of the above cases, excluding the case of ceasing insurance altogether, the risk presented to the insurance company is substantially reduced as the automobile will not be in service but will be stored in a secure lot. In this situation, the vehicle is not subject to being used on the streets where it can collide with other automobiles or collide with objects thus presenting collision damage to the vehicle. The automobile is not in operation by a user and, therefore the issue of bodily injury coverage and other such liability coverage should be irrelevant. When an automobile is in storage during the time of deployment of military personnel, the principle risk to the automobile is that of damage to the property value represented by the automobile through some act of nature or vandalism. Acts of vandalism should be considerably reduced as the car is in a secure storage facility operated by a military base or approved of by a military base, and therefore should present a minimization of the potential for vandalism damage to the automobile. Also, depending upon the type of storage facility, the automobile may not be subject to damage from weather conditions that might be present in an open storage facility. In a covered or closed storage facility the only potential weather damage the automobile may be subject to is the absolute catastrophic damage to the facility itself such as a tornado or a flood, etc. If the automobile is stored in an open storage facility, there is a slight increase in the possibility of damage to the vehicle by the elements such from catastrophic rain or hail or sun or other such weather-type damage, in addition to the potential for catastrophic damage by tornado, flood or hurricane etc.

Therefore, a method of insuring automobiles of military personnel who are deployed overseas or deployed in long distance deployments and which offered a method of determining that the military service member was deployed overseas or deployed at a long distance from their normal base of operations, and that their personal automobile had been stored on a military base or military approved storage lot during the course of that deployment, and which provided a benefit to the military service member commensurate with the reduction of risk presented to the insurance company would be of great benefit to military service personnel. It will be appreciated by those skilled in the art that any such reduction in coverage contemplated under the inventive method would conform to the requirements of any lien holders on the automobile and or and state insurance requirements for retaining a licensed vehicle within the relevant state of registration. Such modifications to a base policy of insurance during a period of deployment could include a reduction or suspension of liability coverage to a minimum amount required to maintain a valid registration and license of the vehicle during deployment, a reduction or suspension of collision coverage to the minimum allowed by the lien holder, or a reduction in the policy premium for the period of deployment in some relation to the reduction in risk as rated by the insurance company offering the policy of insurance.

In operation the inventive method of insurance would function as follows. Upon receiving orders for deployment overseas or for deployment to a station or base a distance away from the normal station or base of operations for the individual in military service, the individual service member would notify their automobile insurance provider of their orders. Typically, such a deployment would be for a time greater that one month. A copy of the orders either would be provided to the insurance provider, or if information regarding the deployment is not to be made public, a designated officer in command of the individual being deployed, or other suitable military authority, could certify that the circumstance of the individual's departure from their regular base of operation qualifies under the insurance policy requirements for receiving the benefit of the present invention. It will be appreciated that such orders can be either individual orders or unit orders and that verification of either to the insurance company would be contemplated under the present invention. Alternatively, the military service member could provide the insurance provider with a custody receipt from the vehicle storage lot to show that custody of the vehicle had been tendered to the vehicle storage lot, or with a vehicle inspection form from a vehicle storage lot could be provided to show transfer of custody. Typically, a vehicle storage facility will conduct an inspection of a vehicle at the time it takes custody of the vehicle to account for any pre-existing damage on the vehicle and to record the mileage appearing on the odometer of the vehicle at the time the vehicle storage lot take possession or custody of the vehicle.

Once the initial notification of deployment or qualification for policy benefits is received from the insured or their superior officer, the insured is then required to submit proof of their storage of the automobile on a pre-qualified storage lot. Such a pre-qualified storage lot can be a secure lot which exists on a military base and which is provided by the military for such personal storage of automobiles or the lot may be one which is a private lot but which is approved by the military or the insurance provider or insurance company for long-term storage of the automobile. The submission of proof of storage on a qualified lot could be a bailment contract or storage contract or a storage receipt or a notification directly from the operator of the storage lot that a particular automobile bearing a particular vehicle identification number (VIN number) had been received on the lot. Upon receipt of these qualifying requirements from the individual and submit of proof of storage from the individual or the storage lot, the benefit options provided under the policy of insurance would then be activated to thereby provide the benefit to the insured. It will be appreciated that presentation to the insurance provider of a vehicle inspection form from the vehicle storage facility is sufficient as the purposes and interests of the insurance provider and the storages company are similar to the extent that both need a demonstration of the initial odometer reading of the vehicle and both require evidence of the damage-state of the vehicle upon the initiation of storage of the vehicle. The storage facility needs such information to verify the receipt condition of the vehicle and the insurance company needs such information both to verify the receipt condition of the vehicle and to verify receipt of the vehicle by the storage facility.

Various options can be provided under such a policy of insurance to reflect a benefit to the insured based upon the reduction in risk presented to the insurance company. Typical benefit options can consist of a policy premium discount, a refund of a portion of the premium paid on the policy during the period the automobile is in qualified storage, an automatic extension of policy length, and an automatic renewal of the insurance coverage on the vehicle during the periods for which it is in qualified storage. Each of these benefit options will be discussed in turn.

One type of policy benefit which may be offered to a policy holder under the present invention is the option of the overall cost reduction of the policy. Under this method, the policy holder's existing policy premium is reduced by an amount commensurate with the risk reduction as determined by the insurer. Risk reduction would obviously be due to many factors, such as the length of time the insured is overseas or on long distance duty, and the length of time the automobile is in storage, the protection and security of the storage lot which would include whether or not the lot is a guarded lot, whether or not the lot protects the vehicle from the elements, such as an indoor lot, and whether there is a twenty-four hour security patrol of the lot.

Another policy benefit which could be offered to an insured is the refund of a portion of the premium at the conclusion of the overseas or long distance deployment. Under this option, the insured would continue to pay the normal premium rate but would demonstrate to the insurance company that the deployment was terminated and would demonstrate the length of the deployment, and that the car was properly stored during that period of time of deployment. Once the insured had presented this information to the insurance company, a portion of the premium previously paid by the insured could be refunded or an equivalent amount of value such as pre-payment of future premium could be credited to the insured. The rationale for offering this type of post deployment proof of storage of the automobile and deployment would be useful in the situation in which the military service person, for security reasons, was not permitted to identify to any third party that overseas or long distance deployment had been ordered.

Yet another policy benefit which might be provided under the present invention is extension of the policy duration. Under this option, the premiums paid to the insurance company would remain the same, however, an additional length of time would be added to the term of the policy to account for the reduced risk to the insurance company as a result of the automobile being stored and to provide a commensurate benefit to the insured for the reduced risk sustained by the insurance company.

Yet another benefit option which might be provided under the present invention is an automatic renewal of coverage guarantee for the term that the vehicle is stored and the service person is stationed overseas or at a long distance deployment. The benefit to this type of policy benefit is that during periods of overseas deployment or long distance deployment, it is often difficult for military personnel to attend to timely payment of bills and execution of documents due to the great separation of the individual from their home base or from civilization. By way of example, if a sailor is deployed on a submarine which may sail for many months at a time without any available communications methods for the crew, it would not be possible for the sailor to effect the renewal of an automobile insurance policy. Under the contemplated automatic renewal of coverage benefit, the insurance company would continue to extend the insurance coverage on the property during the period of deployment and would not allow coverage to lapse until some specified time after deployment had terminated.

It will be clear to those skilled in the art that other specific forms of policy benefits can be offered to the insured under the present invention. The previously described benefit option should be understood to be examples of possibilities rather than limitations on the scope of the invention. To now more particularly describe the operation of the invention, a specific phantom example cast in the future tense so as not to indicate execution by the inventor will now be described.

In such a phantom example, a military service person being a soldier, a marine, a sailor or an airman will receive orders for their deployment overseas to a base in Europe. In this example, the secrecy surrounding the orders would not be an issue, thus the service person would be permitted to present a copy of the orders to their insurance company. Upon receiving the orders, the insurance company will offer a list of approved secure lots or ask the insured to identify the proposed secure lot for storage of their vehicle. An approved lot will then be selected and the insured will execute storage of the vehicle at the selected secured lot and obtain documentary proof from the lot of the storage or will ask the storage lot to certify directly to the insurance company that the vehicle is, in fact, stored on the lot. When the storage of the vehicle on the qualified lot is proved to the insurance company the initiation of the policy benefit option will begin, or qualification for receiving the policy benefit upon return of the military service member from deployment will begin. The selection of the policy benefit option could either be a selection made by the insured or a selection made by the insurance company and offered to the insured as the only option or one of several options. The military service person will then depart for deployment, and the conduct of the insurance policy is governed by the specific terms of the policy including the terms offering the policy benefit option to the insured during the course of deployment.

Upon return of the insured from deployment, the insured military service personnel person will contact the insurance company and certify the end of their deployment and their intent to remove their vehicle from the secured storage lot. When the car leaves the lot, the policy benefit option terminates, and the policy may continue to operate by reverting to its original terms and levels of collision and liability insurance for which the insured contracted at the time of initiation of the insurance policy.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the invention is by way of example, and the scope of the invention is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method of providing an insurance benefit is offered and used, the characteristics of the method, and advantageous, new and useful results obtained; the new and useful method structures, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A method of obtaining an insurance policy premium discount for vehicle insurance for military service members during deployment of the service member to a location distant from the regular station of the service member or during foreign deployment of the service member the method comprising:
tendering custody of a vehicle possessed by an insured military service member to an eligible vehicle storage facility upon said insured military service member being deployed to a location distant from the regular station of the service member,
notifying an insurance provider of said insured military service member of said tendering custody of said vehicle to said storage facility, and
receiving from said insurance provider an insurance policy premium discount by said insured military service person during a period time beginning approximate with said tendering custody of said vehicle to said vehicle storage facility and ending approximate with a return of custody of said vehicle to said military service person.

2. The method as claimed in claim 1 wherein said step of notifying comprises presenting said insurance provider a vehicle inspection report from said vehicle storage facility.

3. The method as claimed in claim 1 wherein said step of notifying comprises presenting said insurance provider a vehicle custody receipt from said vehicle storage facility.

4. The method as claimed in claim 1 wherein said eligible vehicle storage facility is a military service branch operated vehicle storage facility.

5. The method as claimed in claim 1 wherein said eligible vehicle storage facility is a private vehicle storage facility approved by said insurance provider.

6. The method as claimed in claim 1 wherein said eligible vehicle storage facility is a private vehicle storage facility approved by a military service branch.

7. The method as claimed in claim 7 further comprising the step of maintaining state vehicle insurance requirements on said vehicle in said vehicle storage facility

8. A method of providing an insurance policy premium discount for vehicle insurance to military service members during deployment of the service member to a location distant from the regular base of the service member or during foreign deployment of the service member the method comprising:
receiving by an insurance provider a notice of a tendering custody of a vehicle possessed by an insured military service member to an eligible vehicle storage facility upon said insured military service member being deployed to a location distant from the regular station of the service member, and
providing by said insurance company a discount of an insurance policy premium to said insured military service person during a period time beginning approximately with said tendering custody of said vehicle to said vehicle storage facility and ending approximately with a return of custody of said vehicle to said military service person.

9. The method as claimed in claim 7 wherein said step of notifying comprises presenting said insurance provider a vehicle inspection report from said vehicle storage facility.

10. The method as claimed in claim 7 wherein said step of notifying comprises presenting said insurance provider a vehicle custody receipt from said vehicle storage facility.

11. The method as claimed in claim 7 wherein said eligible vehicle storage facility is a military vehicle storage facility.

12. The method as claimed in claim 7 wherein said eligible vehicle storage facility is a private vehicle storage facility approved by said insurance provider.

13. The method as claimed in claim 7 wherein said eligible vehicle storage facility is a private vehicle storage facility approved by the military.

14. The method as claimed in claim 7 further comprising the step of maintaining state vehicle insurance requirements on said vehicle in said vehicle storage facility
